(19) United States
(12) Patent Application Publication
(10) Pub. No.: US 2025/0036485 A1
(43) Pub. Date: Jan. 30, 2025

(54) COMPUTATION ON A DATA STREAM

(71) Applicant: Arm Limited, Cambridge (GB)

(72) Inventors: Balaji Venu, Cambridge (GB); Metin Gokhan Ünal, Gamston (GB); Giacomo Gabrielli, Cambridge (GB); Damian Piotr Modrzyk, Katowice (PL); Dino Santoro, Cambridge (GB)

(73) Assignee: Arm Limited, Cambridge (GB)

(21) Appl. No.: 18/782,668

(22) Filed: Jul. 24, 2024

(30) Foreign Application Priority Data
Jul. 26, 2023 (GB) 2311434.1

(51) Int. Cl. G06F 9/52

(52) U.S. Cl. CPC G06F 9/52

(57) ABSTRACT

Provided is a data stream processor comprising: a configurable compute unit comprising plural processing units each configured to receive at least one portion of input data and process the at least one portion of a repetitive arithmetical/logical operation on the data; an input memory unit in electronic communication with the configurable compute unit and configured to supply at least one portion of the input data to at least one of the plural processing units in the configurable compute unit; and at least one accumulator unit in electronic communication with the configurable compute unit and configured to receive at least two portions of processed data from the configurable compute unit and to output accumulated data; wherein each of the plural processing units is further configured to forward its processed data to a next processing unit and/or to an accumulator unit.

The present technology is directed to the provision of data stream processors configured to execute repetitive or patterned arithmetical/logical operations (such as computer vision or image processing operations) on data, possibly according to stencil processing algorithms. In image processing and computer vision tasks, it is frequently necessary to perform sequences or arrangements of instructions in a patterned or correlated manner—one example of this type of processing is stencil processing.

Stencil processing operations are a widely-used type of data processing operations in which fixed patterns can be applied repetitively to subsets of sets of data (for example, using a sliding window pattern for acquiring the data to be processed), and typically involving some dependencies among the data elements of the subsets and/or correlations among the operations to be executed at each instance of the stencil's application. Stencil operations are well-adapted to take advantage of spatial and temporal locality in data, and can provide advantages in efficiency of processing and in economy of resource consumption, by, for example, reducing the number of memory accesses required to perform a process that features repetitions and correlations.

A typical example of a processing entity that is capable of performing repetitive or patterned arithmetical/logical operations on data is a Graphics Processing Unit (GPU). Conventional GPUs were designed for the specific purpose of processing inputs in the form of, typically, annotated mathematical (usually vector) representations of images, extracting geometrical forms and their positions from those representations, manipulating and interpreting annotations describing characteristics of elements in the images (such as colour and texture), and providing outputs suitable for controlling the rasterization of a final output image to display buffers ready for display on an output device, such as a display screen or a printer. In performing these functions, GPUs frequently operated in a single instruction, multiple data mode to perform repetitive arithmetical/logical operations on data.

In conventional GPUs, there are sub-units providing the various functions required for the computational processing of graphics, the sub-units having access to a dedicated memory subsystem and also typically having one or more caches used for input and output buffering and for intermediate data storage during processing and usually providing high-speed data load and store operations. The units providing these functions are typically operable in parallel processing pipelines to handle the often very large amounts of data that need to be processed.

Because GPUs are characterised by their ability to process very large sets of data, using massive parallelism, at the very high speeds needed for detailed rendition of still or video graphics on screens, developers have observed that they are also well adapted to other uses, such as processing the very large statistical data sets needed for scientific, medical and pharmacological data analysis and for artificial intelligence inferencing.

It is thus now known in the art to use GPUs to perform other functions—for example, it is known to exploit the built-in parallel processing capabilities of GPUS to perform non-graphics-related computations, such as computations on statistical data sets or machine-learning neural network tensor data. The parallel processing capabilities of GPUs make possible the concept of the general purpose GPU (or GPGPU), operable alongside conventional CPUs to take on some workload that is in need of such parallel processing capabilities. This is typically achieved by using special purpose software that is adapted to exploit the strengths of GPU hardware for these non-graphics-related functions.

Recently, developers have realised that it is also possible to exploit the parallel processing power of GPUs to perform visual data processing, such as image processing, by enabling the sub-units to perform the computations required to process the computer vision or image data, under control of specialised software.

The type of visual data processing or image processing envisioned here is the processing of input data from a camera or other image capture device to prepare the data (typically using image-to-image manipulations, such as image simplification, normalization and transformation) for computational operations such as image recognition, and this clearly differs from the conventional use of GPUs.

In an approach to addressing some difficulties in providing efficient, and possibly low power-consumption, repetitive arithmetical/logical operation processing of data such as image or computer vision data, the present technology provides a data stream processor according to the appended claims.

In other approaches, there may be provided a method of operating a data stream processor according to the present technology, and that method may be realised in the form of a computer program operable to cause a computer system to perform the process of the present technology. As will be clear to one of skill in the art, a hybrid approach may also be taken, in which hardware logic, firmware and/or software may be used in any combination to implement the present technology.

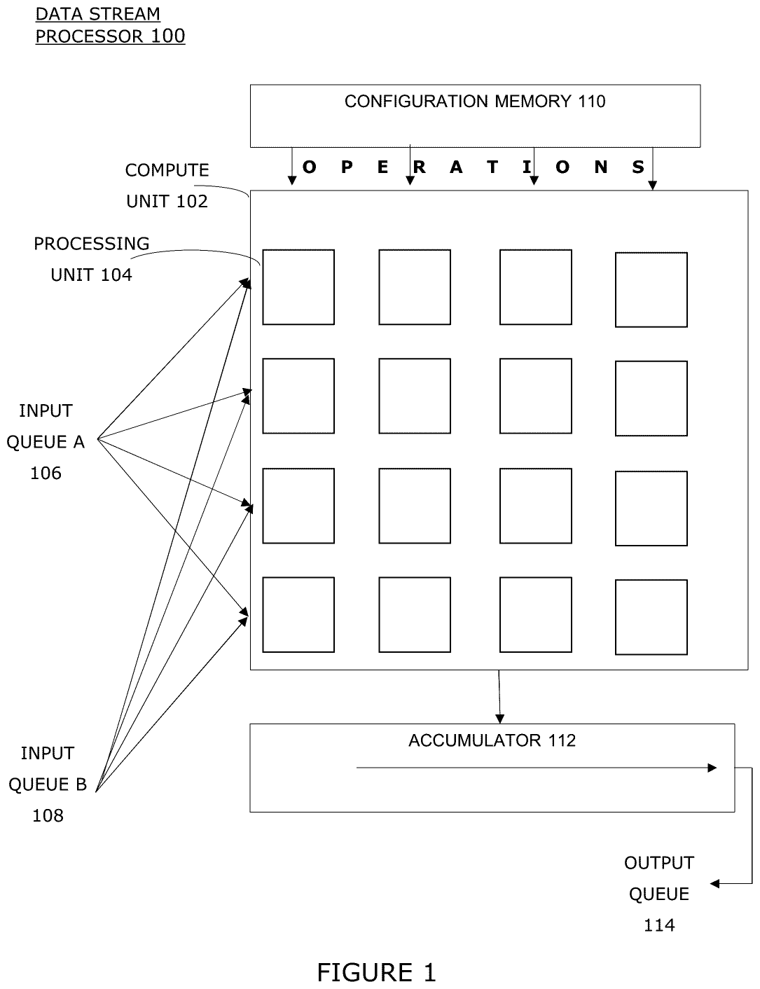

FIG. 1 shows a simplified example of a data stream processor according to an implementation of the present technology and comprising hardware, firmware, software or hybrid components;

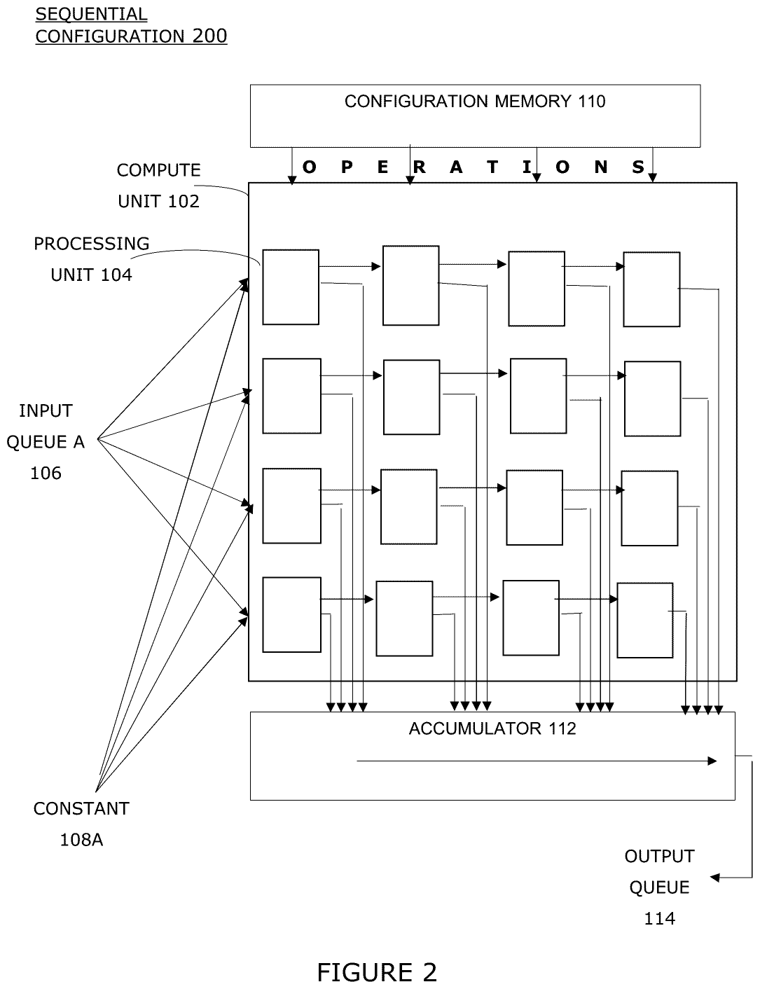

FIG. 2 shows a possible sequential operation configuration of the apparatus according to the present technology and comprising hardware, firmware, software or hybrid components;

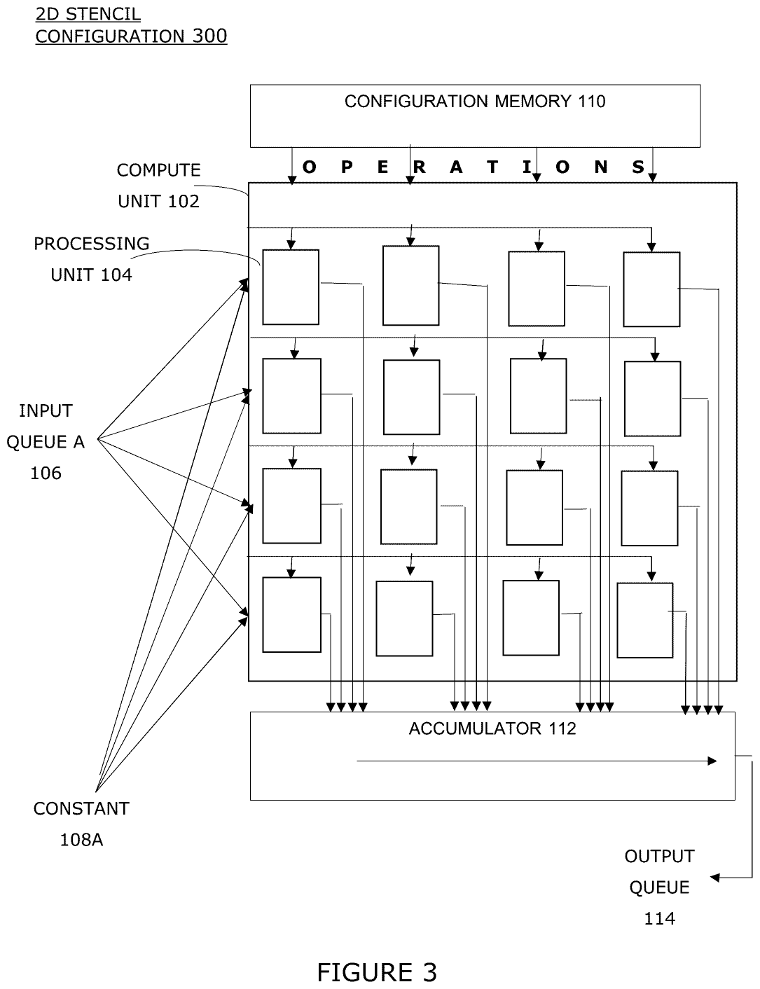

FIG. 3 shows a possible 2D stencil operation configuration of the apparatus according to the present technology and comprising hardware, firmware, software or hybrid components;

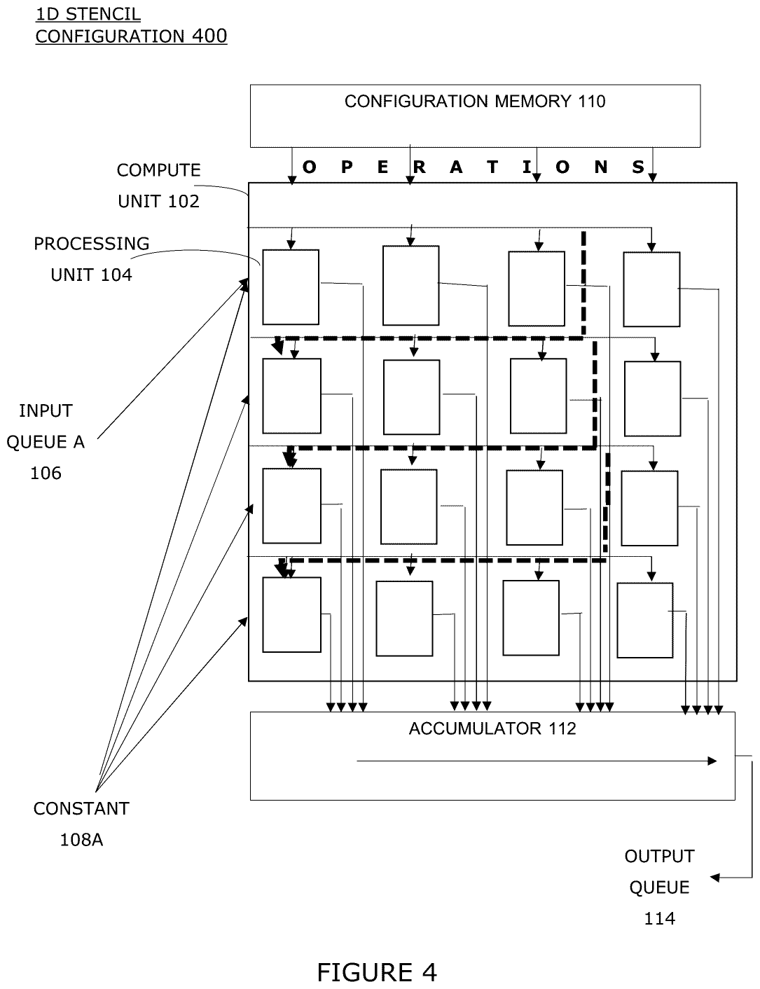

FIG. 4 shows a possible 1D stencil operation configuration of the apparatus according to the present technology and comprising hardware, firmware, software or hybrid components;

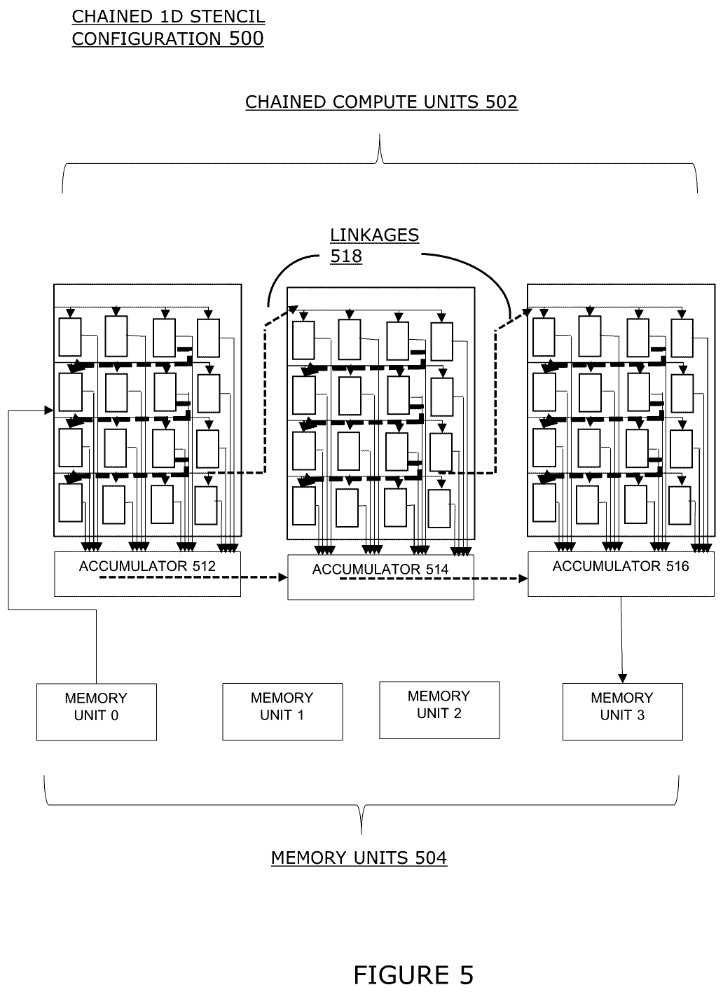

FIG. 5 shows a possible structure using chained compute units in a 1D stencil configuration of the apparatus according to the present technology and comprising hardware, firmware, software or hybrid components;

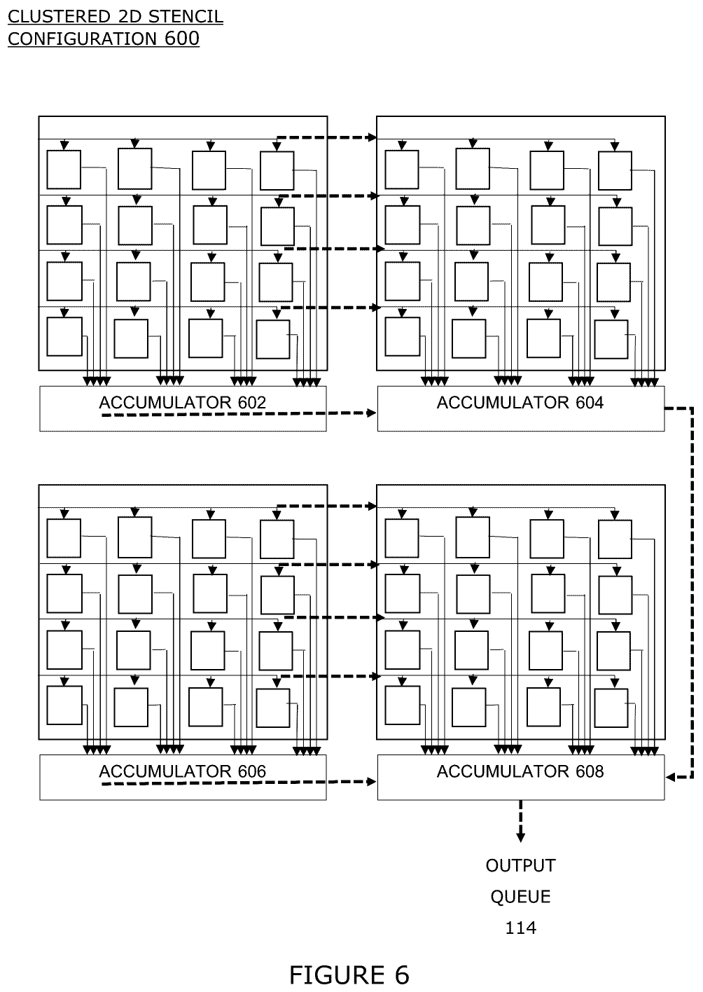

FIG. 6 shows a possible structure using clustered compute units in a 2D stencil configuration of the apparatus according to the present technology and comprising hardware, firmware, software or hybrid components;

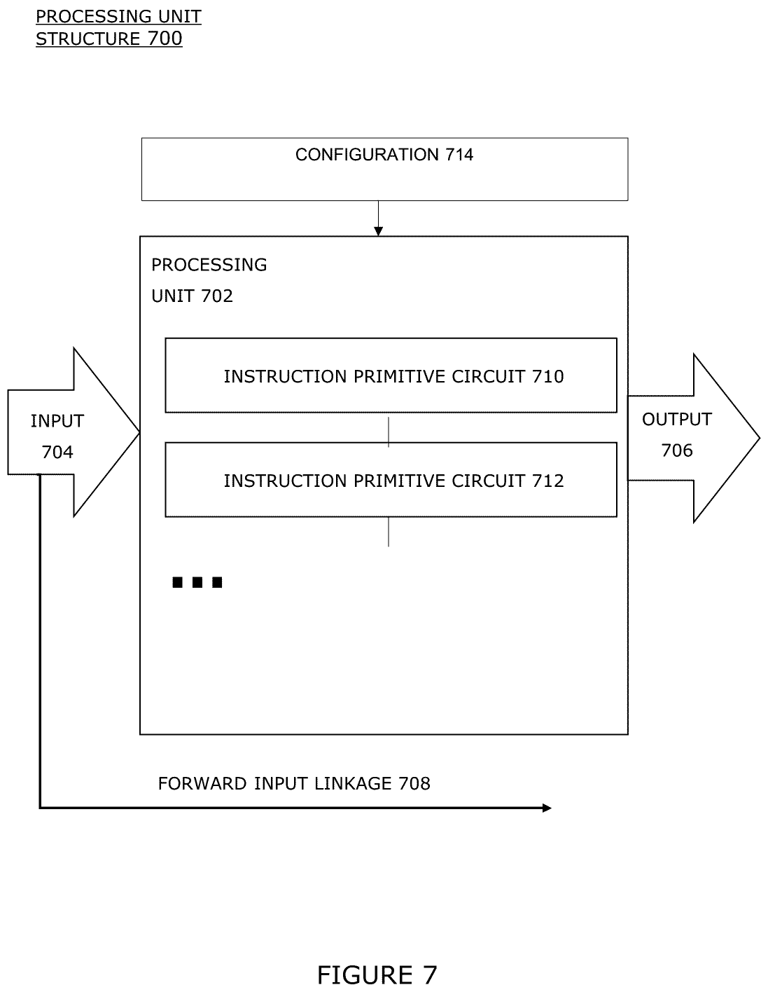

FIG. 7 shows a possible implementation of a processing unit structure according to the present technology; and

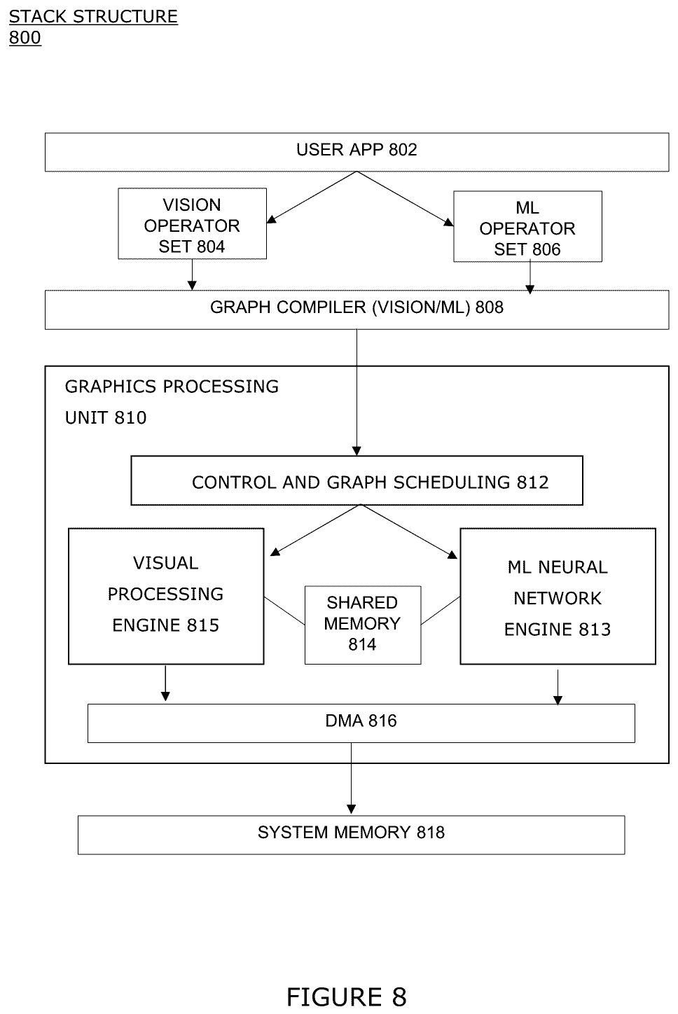

FIG. 8 shows an example of a stack structure of hardware, firmware and/or software into which the present technology may be incorporated.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter. Thus, seen broadly, the present technology provides a configurable, repetitive or patterned operation data stream processor composed of at least one compute unit and at least one memory unit implemented using dataflow principles. The compute unit comprises arrangements of processing units (typically arranged in array form of rows and columns) that can be configured to operate in different ways based on a setup conveyed by a configuration memory or instructions. The processing units can receive data from input queues in a memory unit and from one another in various arrangements of linkages.

Because of their high performance per Watt of power consumed, GPUs have become desirable computing platforms for implementing computational imaging and vision pipelines. As is known in the art, one estimate is that a GPU-implemented vision processing pipeline can result in an approximately five to ten times better performance efficiency (in performance per Watt) than a conventional CPU-based implementation. Typically, the camera, imaging, and computer vision pipelines mapped to the GPU hardware are realised by using the facilities provided by GPU shader software programs. These GPU shader software programs make use of the available GPU hardware resources, typically by using the facilities of a texture unit (TU) for hardware sampling from the image frame buffers, the facilities of an execution unit (EU) for arithmetic data paths (integer, or floating point), and the facilities of a post-processing unit (PPU) for final post-processing tasks like 2D blit (rapid data move/copy in memory) operations, composition operations like alpha compositing, colour space conversions and the like.

Thus the use of a GPU can be an effective alternative to the use of a CPU for solving complex image processing tasks. The performance per Watt of power consumed of optimized image processing solutions on a GPU is much higher than the performance of the same functions on a CPU. As will be clear to one of ordinary skill in the art, the GPU architecture allows parallel processing of image pixels which, in turn, leads to a reduction of the processing time for a single image and thus reduced latency for the system as a whole.

For image-related tasks that require the use of neural networks (such as image recognition), the provision in GPUs of hardware tensor kernels can significantly improve performance. High performance GPU software can reduce hardware resource usage in such systems, and the high energy efficiency of the GPU hardware reduces power consumption. Thus, a GPU has the flexibility, high performance, and low power consumption required to represent an attractive alternative to highly specialized field programmable gate array and application-specific integrated circuit systems, especially for mobile and embedded image processing applications. In a GPU configured in this way, visual data processing can be performed by the execution and/or texture units, or inside the neural network engine, but this typically leads to monopolisation of the arithmetical/logical capacity of these units, and hence the overall pipeline performance is degraded. In addition, software-controlled adaptation of these processing units to perform visual data processing to some extent detracts from their efficiency, as they are specifically designed for the different requirements of conventional graphics processing tasks.

The uses of computer visual processing are expanding with the developments in the use of, for example, robots and other autonomous systems requiring fast and accurate computer vision, augmented reality devices and applications, and artificial intelligence systems needing large scale learning data that may include visual representations to be provided in a usable form.

With the increased amount and importance of visual image computing, the present technology addresses some of the performance deficiencies encountered in known techniques of using a conventional GPU under high-level software control for classic image processing, by integrating a vision engine into a GPU shader core, where it can seamlessly interoperate with the execution units and the other graphics specific units, as well as with the neural network engine when inferencing is required, either to achieve part of the image processing task or to operate on the output of the visual processing engine as a post-process task.

The processing units of the present technology are particularly well-adapted to perform a limited set of primitive visual processing operators from which any higher-level operators may be constructed, thereby forming a hardware/firmware/software stack implementation of a visual processing architecture arranged according to the following rules:
R1. An operator shall be a primitive operation or building block that cannot be decomposed into simpler whole visual operations;
R2. An operator shall be reusable as a component out of which more complex operations can be constructed;
R3. Precision should be appropriate for the input and output data types (as high as needed, but not wastefully higher);
R4. Numerical definition of common sub-operations should be consistent between operators (for example: image feature scaling);
R5. The valid input and output ranges for all operands shall be specified; and
R6. Integer operators shall be implementable in a bit-exact form with good efficiency. on CPU, GPU and hardware targets.

The visual processing architecture defines a set of primitive operators according to the rules to which higher level operators can be consistently reduced—the present technology provides a base upon which such an architecture can advantageously be implemented.

Each of the processing units in a compute unit according to the present technology is specifically adapted to perform data processing on at least a portion of a data stream according to the primitive operator for a received configuration instruction.

The processing architecture defines a set of primitive operators according to the rules to which higher level operators can be consistently reduced—the present technology provides a base upon which such an architecture can advantageously be implemented.

Each of the processing units in a compute unit according to the present technology is specifically adapted to perform data processing on at least a portion of a data stream according to the primitive operator or combination of operators for a received configuration instruction. There is shown in FIG. 7 a processing unit structure 700 according to implementations of the present technology. The structure comprises a configurable processing unit 702 operable in electronic communication with other entities to receive input (which may be from a wholly external entity, or may be from another peer processing unit according to the arrangement of the processing units within a compute unit). Processing unit 702 comprises an input 704, an output 706 and a forward input linkage 708, for those cases in which the input is to be received at this processing unit and also forwarded in its current state to a further processing unit. Processing unit 702 is arranged in electronic communication with configuration 714 (each processing unit 702 may be provided with a portion of configuration 714, in, for example, a configuration register) to accept configuration instructions that cause processing unit 702 to perform operations and to establish linkages to other entities as instructed. Processing unit 702 comprises instruction primitive circuits 710, 712 . . . that are operable to accept configuration instructions, for example to assemble themselves into higher-level instructions, and to perform operations on input data.

By providing a structure in which sets of processing units designed to perform these primitive operators can be reconfigured in various sequential and parallel structures to perform their operations on visual or image data, the present technology advantageously exploits the performance and efficiency characteristics of GPU architecture. Within a compute unit, the processing units can pass data directly to one another in various arrangements of linkages or they can pass data via a memory in a memory unit. In one arrangement, the data can pass as a continuous stream through an array of processing units to perform sequences of operations as instructed by the configuration memory or received instructions. In another arrangement, the compute unit may have its processing units operating in various stencil modes, to perform stencil-type operations (operations in which an action on one element of a data set are conditioned by operations on neighbouring or related elements of the data set). In yet a further arrangement, the compute unit may have its processing units configured to perform a hybrid of arrangements of operation types, for example, by varying the linkages by row, column or n-dimensional subset. The processed data from the processing units may be accumulated and post-processed, for example by data reduction, at an accumulator, before being passed to an output queue in the memory unit.

Additional configurability and scale can be achieved at the level of the compute units by arranging their external linkages to form chains, thereby increasing the number of processing units that can be brought to bear on the input data stream.

The present technology is architected to provide native support for the efficient execution of common computer vision and image processing operations. The compute unit is fed data using a specialised memory unit that is operable to look up data in line buffer and circular buffer (or FIFO) modes from memory units, such as SRAMs. The common computer vision and image processing operations for which the present technology is particularly adapted comprise:
One-dimensional and two-dimensional convolution
Colour space conversion
Image resize operation (Upscale and Downscale)
   Bilinear
   Bicubic
Piecewise linear approximation
Image filters
Image reduce operations

As will be clear to one of skill in the art, the common computer vision operations can benefit from the characteristics inherent in systems arranged according to the present technology, because the present technology is particularly suited to operations involving the different forms of data locality. One set of computing operations of the sort envisioned here are stencil type operations (where an action taken on an element of a data set affects and/or is affected by the relative positions of the data elements and/or actions taken on neighbouring elements)—the present technology is operable in at least one of its configurations to efficiently exploit spatial locality to perform these operations. This is achieved using a set of processing units configured to operate in a sliding window mode as required to perform, for example, one-and two-dimensional convolution, Resize_Bilinear and Expand operations.

In another of the configurations, the present technology is operable in at least one of its configurations to perform, for example, image reduction operations such as Reduce_Interpolation_Channelwise, Reduce_Max_Planewise, Reduce_Sum_Channelwise, and the like.

In both the exemplary configurations described above, scalar reductions and efficient stitching of data are required to achieve the desired result.

Turning to FIG. 1, there is shown a simplified example of a data stream processor 100 according to an implementation of the present technology and comprising hardware, firmware, software or hybrid components. Central to the data stream processor 100 of FIG. 1 is compute unit 102, which in turn comprises a set of processing units 104—here shown arranged as a grid of squares within the borders of compute unit 102, although this arrangement is an abstract representation and need not be implemented in this form in any physical electronic structures of the present technology. For simplicity of reading the figure, only the top left processing unit 104 is indicated with a call-out in the figure. Also for simplicity, the grid of processing units 104 has been shown as a 4×4 arrangement. In any real-world implementation, there may be many more processing units 104, arranged in any n-dimensional format. The processing units 104 are also shown here without linkages, although it is envisioned that physical linkages will exist in any real-world implementation—the linkages of the processing units 104 at the point of operation of the system are controlled and configured by OPERATIONS (as shown) according to parameters in configuration memory 110. Some of the possible configurations of linkages and of operations to be performed by the processing units will be shown in further figures and the accompanying descriptions hereinbelow. Data to be processed by processing units 104 is provided to compute unit 102 by input queues, for example, input queue A 106 and input queue B 108. When the data that was input at, input queue A 106 and input queue B 108 has been processed by processing units 104, the results data are provided by various linkages (shown in more detail hereinbelow with reference to further figures) to accumulator 112. Accumulator 112 may be configured to perform aggregation and further manipulation of the results data (for example, various forms of data reduction and the like) and stitching the data together, before passing the processed data to output queue 114. In an alternative in which there is a chain of compute units, output queue 114 may be bypassed and the data may be passed directly to one or more further compute units for additional processing.

Thus, each compute unit within a data stream processor has a grid (or other layout) of processing units interconnected with streaming interfaces. The processing elements process the incoming streamed data and forward either the incoming streamed data to another processing unit or forward the output to another processing unit or to the accumulator for output to a memory unit.

To address efficient repetitive and stencil-type operations, the present technology incorporates data forwarding techniques that are operable to take advantages of the spatial characteristics of the incoming data and the types of operation that are typically required for visual or image processing.

In the sequential mode of operation, the output of each processing unit in a column is forwarded to the corresponding processing unit in the next column. This mode of operation is adapted to the operations required by many image processing tasks, in which there are regular sequences of operations such as Add followed by Sub and then Mult. Instead of having a dedicated register file to write to and read, this fabric supports direct shifting of data to the processing units in the next column.

The sequential mode of operation or sequential configuration 200 of the data stream processor (100 of FIG. 1) is shown in FIG. 2, in which it can be seen that the inputs to the rows comprise individual per-row data from input queue A 106 and a constant 108A passed to each row from input queue B (108 of FIG. 1). As will be clear to one of skill in the art, the use of a constant as a coefficient is merely selected as an example, rather than being a necessary feature of this mode of operation. The mode of operation of the processing units 104 and their linkages is determined by the instructions provided from configuration memory 110. In this case, the output from each processing unit 104 of the first three columns is passed to accumulator 112 and to the next sequential processing unit (that is the corresponding processing unit in the next rightward column). Accumulator 112 receives as input the results for the processing units 104, performs its “post-processing” tasks (such as data reduction tasks) to make the data suitable for output, and then forwards the results data to output queue 114. The efficiencies gained by exploiting the direct linkages between processing units 104 to pass data without needing intermediate memory writes and reads will be abundantly clear to one of ordinary skill in the computing art.

Turning now to FIG. 3, there is shown a possible two-dimensional stencil configuration 300 of a data stream processor (100 of FIG. 1) according to the present technology. Two-dimensional stencil processing is typically applied where a cluster or pattern of operations is required to be performed repetitively on a group of subsets of data, where the individual operations in the cluster have a dependency upon the two-dimensional spatial arrangement of the data. The stencil operation is typically carried out by passing a moving window across the data and performing the same pattern of operations at each of a set of positions in the data.

In this mode, initial inputs to the rows comprise individual per-row data from input queue A 106 and a constant 108A passed to each row from input queue B (108 of FIG. 1). The input to each of the leftmost columns is then forwarded to the next immediate rightward column on each processor cycle, as shown by the arrowed lines originating the left border of compute unit 102. This permits the efficient mapping of visual or image processing operations that require two-dimensional moving window calculation patterns. A straightforward example is convolution, but there are other uses cases such as image resize upscaling which can benefit from forwarding input data from one column to the next column. For some of the visual or image processing operations, the process may require inclusion of a two-dimensional buffer that can be written diagonally and read sequentially as the image flows through the fabric. This is, for example, needed for image resize operations, but not for convolution.

Turning now to FIG. 4, there is shown a possible one-dimensional stencil configuration 400 of a data stream processor (100 of FIG. 1) according to the present technology. One-dimensional stencil processing is typically applied where a linear pattern of operations is required to be performed repetitively on a group of subsets of data, where the individual operations in the cluster have a dependency upon the one-dimensional or temporal arrangement of the data. The one-dimensional stencil operation is typically carried out by passing a sliding window linearly along the data and performing the same pattern of operations at each of a set of positions in the data.

In this mode, initial inputs to the rows comprise individual per-row data from input queue A 106 and a constant 108A passed to each row from input queue B (108 of FIG. 1). As with the two-dimensional configuration described above with reference to FIG. 3, the input to each of the three leftmost columns is then forwarded to the next immediate rightward column on each processor cycle, as shown by the arrowed lines originating the left border of compute unit 102.

The two-dimensional configuration of FIG. 3 is well-adapted for handling data where relatively small, spatially-contiguous subsets of the data are to be handled using stencil-type operations. In many computer vision and image processing algorithms, the processing kernels may be designed to be separable, so that computational complexity can be reduced from O(N\hat{ }2) to O(2N). In order to efficiently support this mode of operation, the present technology permits input data forwarding to happen in a one-dimensional fashion as shown in FIG. 4, while retaining the per column operation code configuration of FIG. 3. The extra bold arrow shows the difference between the two-dimensional and one-dimensional stencil configurations. In this configuration, the input to the last processing unit 104 of each column is supplied as input to the leftmost processing units 104 of each row in the next processing cycle. The one-dimensional chain shown below is thus 16 processing units long, and is thus able to cope with large filters such as those used in image blurring. The configuration can also be partitioned as two 8 processing unit chains if that is required for better resource utilization.

In both the stencil-type processing configurations, there is a requirement for data lookup support in line buffer mode in the memory. Taking a two-dimensional image as an example, the pixels are defined in memory using a Cartesian co-ordinate system (x,y) where ‘y’ denotes the row or line number and ‘x’ denotes the column number.

If the available bandwidth for the lookup is 4, the memory organization and read capabilities for this type of data lookup can permit the reading of:
1×4 (pixel lookup)
2×2 (box lookup)
m×n lookup, provided that m*n<4

The read and write phases are implemented using self-throttling mechanisms, keeping the control logic to a minimum.

In addition to the above-described homogeneously-defined configurations, each column of processing units 104 in the compute unit 102 can be configured to operate in a different mode. One such case is when some columns need to operate in stencil processing mode and some in sequential mode. For implementing colour space conversion, for example, the configuration may have the leftmost two columns configured to perform in a sequential configuration, while the rightmost two columns are configured to perform in a two-dimensional stencil configuration.

In all the configurations described hereinabove, compute unit 102 is operatively coupled with accumulator 112, which is operable to perform what are, in effect, post-processing actions on the data provided by processing units 104. As will be clear to one of ordinary skill in the art, the data produced by the processing units 104 may require such post-processing to render it into a form suitable for output in output queue 114. For all the above modes of operation, the accumulator 112 provides a Reduce_Columnwise, Reduce_Rowwise and a Reduce_all capability.
Reduce_Columnwise—By this operation, the outputs of a particular column of processing units 104 are added;
Reduce_Rowwise—By this operation, the outputs of a particular row of processing units 104 are added;
Reduce_all—By this operation, outputs of all the processing units 104 are added.

In a further implementation, there may be provided various techniques to further exploit the possibilities inherent in the data stream processor of the present technology. For example, in addition to the internal exploitation of multiple arithmetical/logical processor units inside a compute unit, there may be provided ways of configuring data stream processors at a next higher level of a hierarchy.

Image processing and other computer vision-related operations are achieved using small filter sizes most of the time, but there are outliers to this aspect of computer vision and image processing. For example, very large convolution filters are required in the case of Bokeh filters which selectively blur different portions of an image. Building a monolithic compute unit to support these large filters would lead to huge underutilization when smaller kernels are mapped on to the fabric, and this underutilization is clearly undesirable. Hence, the preferable option to build a large filter size stencil processor (4×8, 8×8, . . . ) is by using multiple smaller compute units and providing features for reconfiguring them to act in conjunction—for example, 4×4 processors. Hardware features to support aggregating multiple 4×4 compute units to create a higher logical size of compute unit (4×8, 8×8, etc) can be provided for the data stream processor according to the present technology.

The hardware features to support chaining or clustering of compute units according to the present technology include:
1) Chain or cluster mode ports to communicate the following to the next compute unit:
   a. Input data
   b. Output of accumulator block
2) Configuration registers that specify the arrangement of compute units operating in chained or clustered mode.
3) Optionally, a separate power gate arrangement for any under-utilized intermediate memory units, so as to save on power consumption.

FIG. 5 shows a possible structure using compute units configured as a chain in a 1D stencil operational mode of the apparatus according to the present technology. The figure shows an arrangement for operating the compute units of a data stream processor in a chained configuration in 1D STENCIL mode. This configuration and operating mode permits the use of large filters—up to the number of processing units that form the pathway through the chain of compute units. As will be clear to one of skill in the art, this arrangement of the three compute units is merely exemplary, and in a real-world arrangement, there may be many compute units in the chain.

In FIG. 5, the chained compute units 502 are operable to communicate with memory units 504 and are provided with input by one or more input queues in memory unit 0 (the inputs corresponding to those shown at 106 and 108A of FIG. 4). The input of the last processing unit of the first two compute units in the chain is provided as input to the first processing unit of the succeeding compute unit (as shown by the heavy dotted arrow). The output of the first compute unit to accumulator 512 is processed and forwarded (as shown by the first heavy dotted arrow of LINKAGES 518) to accumulator 514 to be aggregated and further processed with the output of the second compute unit before forwarding to accumulator 516 for similar handling. The output of accumulator 516 is then passed to the output queue in memory unit 3. Memory units 1 and 2, not being required in this configuration, may conveniently be powered down or used for another purpose for the duration of the chained process.

The heavy dotted lines LINKAGES 518 in FIG. 5 represent electronic communication linkages over the extra CHAIN mode ports supported in the hardware architecture of the data stream processor according to this implementation of the present technology. In the above example, the data stream processor is operable to support a 1D kernel with a filter size of up to 48 elements.

Turning now to FIG. 6, there is shown a possible structure using clustered compute units in a 2D stencil configuration of the apparatus according to the present technology. A similar approach to that taken for 1D stencil operations (as described above for FIG. 5) can be followed for STENCIL 2D mode to provide support for a 2D filter size greater than 4×4. The compute units are arranged in a grid formation of the required dimensionality—here, for example, four compute units are arranged in a grid comprising 64 processing units that can accommodate 64 filters to be applied two-dimensionally to a data stream. In this configuration, the inputs are passed from the input queues to each of the leftmost compute units of the grid arrangement. Each of the compute units operates as defined above in the description of FIG. 3, with the additional linkages described below exploiting the hardware ports provided for this clustered mode of operation.

Using the additional linkages, the four last column inputs of the leftmost compute units are passed to the respective leftmost processing units of the respective rightmost compute units. The upper rightmost accumulator unit 604 receives input also from its left neighbour accumulator unit 602, as well as from its own columns of processing units, and passes its results to the rightmost lower accumulator unit 608. The lower rightmost accumulator unit 608 receives input also from its left neighbour accumulator unit 606, as well as from its own columns of processing units, and also receives results, as described, from accumulator unit 604. The lower rightmost accumulator unit 608 completes the processing (data reductions and the like|) of the processed data from the cluster of compute units and provides its output to output queue 114.

In this way, by providing a structure in which sets of processing units designed to perform a limited set of primitive operators can be reconfigured in various sequential and parallel structures to perform operations on visual or image data, the present technology advantageously exploits the performance and efficiency characteristics of GPU architecture. As will be appreciated by one skilled in the art, the present techniques may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

The present technology may be incorporated into a pipeline arrangement (typically implemented in a GPU) that is operable to perform both visual processing and machine learning neural network processing. For example, there may be provided a stack structure 800 as shown in FIG. 8 having tightly-coupled and highly-programmable visual processing and neural network accelerator components, as well as a unified, common control and graph-oriented scheduling layer.

Stack structure 800 may comprise software, firmware and hardware elements including user applications 802 that may incorporate program operators from a vision operator set 804—instructions based on primitives specifically tailored for performing operations on visual data—and operators from a machine learning operator set 806—instructions based on primitives specifically tailored for performing operations on machine learning data, typically tensor data. The user application 802 is processed at least in part by the graph compiler 808, which is adapted to compile both vision operators from 804 and machine learning operators from 806 into a unified program processing graph. Graph compiler 808 is arranged in at least intermittent electronic communication with graphics processing unit 810 to provide compiled graph data to control and graph scheduling component 812, which controls and schedules the activities of visual processing engine 815 and machine learning (ML) neural network engine 813. Visual processing engine 815 and machine learning (ML) neural network engine 813 are operable to make use of shared memory 814 (which may comprise on-chip SRAM memory resources) for local memory operations, and to provide data as required via DMA component 816 to system memory 818.

There is thus provided in this embodiment a single centralised point of control in the control and graph scheduling component 812 which fetches the command stream for the visual processing engine 815 and the ML neural network 813 and controls overall processing and data-flow for the compute stages, as defined by the output of the graph compiler.

Graph-based programming (software) model for both ML and non-ML parts of the vision pipeline, thanks to Vision Processor Graph Compiler incorporating graph-based vision pipeline abstractions leveraging specifically-designed visual processing instruction set architecture and a specifically-designed machine learning tensor-based instruction set intermediate representations.

In this way, the present technology may achieve improved energy efficiency by way of end-to-end visual and machine-learning pipeline scheduling optimised for keeping data on-chip and maximizing utilisation of available hardware resources. This efficiency may combine with improved performance by also avoiding Remote Procedure Calls (RPC) between the host CPU and the visual processing engine. The present technology may further benefit from a reduction in chip area due to increased sharing of the hardware resources in the form of common control, SRAM and DMA resources.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or has the required structure to enable it to be reconfigured or adapted to perform that function. Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed.

The present technology further provides processor control code to implement the above-described systems and methods, for example on a general purpose computer system or on a digital signal processor (DSP). Furthermore, the present technique may take the form of a computer program product tangibly embodied in a non-transitory computer readable medium having computer readable program code embodied thereon. A computer readable medium may be, for example, but is not limited to, an electronic, magnetic, optical, electromagnetic, infrared, or semiconductor system, apparatus, or device, or any suitable combination of the foregoing. Computer program code for carrying out operations of the present techniques may be written in any combination of one or more programming languages, including object-oriented programming languages and conventional procedural programming languages. For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method. In a further alternative, an embodiment of the present technique may be realized in the form of a data carrier having functional data thereon, the functional data comprising functional computer data structures to, when loaded into a computer system or network and operated upon thereby, enable the computer system to perform all the steps of the method.

It will be clear to one skilled in the art that many improvements and modifications can be made to the foregoing exemplary embodiments without departing from the scope of the present disclosure.

1. A data stream processor comprising:
a configurable compute unit comprising plural processing units each configured to receive at least one portion of input data and process at least one portion of an arithmetical/logical operation on the data;
an input to the configurable compute unit configured to supply at least one portion of the input data to at least one of the plural processing units in the configurable compute unit; and
at least one accumulator unit in electronic communication with the configurable compute unit and configured to receive at least two portions of processed data from the configurable compute unit and to output accumulated data;
wherein each of the plural processing units is further configured to forward its processed data to a next processing unit and/or to the at least one accumulator unit.

2. The data stream processor according to claim 1, wherein the configurable compute unit further comprises a configuration operable to provide at least one instruction for execution by at least one of the plural processing units.

3. The data stream processor according to claim 1, wherein the configurable compute unit further comprises a configuration input operable to provide at least one instruction to link an output of a first one of the plural processing units to an input of a second one of the plural processing units.

4. The data stream processor according to claim 1, wherein the configurable compute unit further comprises a configuration input operable to provide at least one instruction to link an output of at least one of the plural processing units to the at least one accumulator.

5. The data stream processor according to claim 1, wherein the configurable compute unit is operable to cause at least one of the plural processing units to execute a visual processing primitive operation.

6. The data stream processor according to claim 1, wherein at least one of the plural processing units is operable to execute an instruction on at least one of a set of data elements.

7. The data stream processor according to claim 1, wherein the configurable compute unit comprises a stencil operation processor.

8. The data stream processor according to claim 1, wherein the at least one accumulator unit is further operable to execute post-processing operations on at least one portion of processed data from the configurable compute unit.

9. The data stream processor according to claim 8, wherein the at least one accumulator unit is operable to execute a data reduction operation on the at least one portion of processed data from the configurable compute unit.

10. The data stream processor according to claim 1, wherein at least two of the configurable compute units are configured to operate in a chain; and wherein processed data is passed directly between the configurable compute units.

11. The data stream processor according to claim 1, wherein at least four of the configurable compute units are configured to operate in a two-dimensional cluster; and wherein processed data is passed directly between the configurable compute units.

12. A method of operating a configurable compute unit of a data stream processor, the compute unit having plural processing units, comprising:
receiving input data at one of the plural processing units in the configurable compute unit;
processing at least one portion of a repetitive arithmetical/logical operation on the data; and
forwarding a result of the processing of at least one portion of a repetitive arithmetical/logical operation to a next processing unit and/or to the at least one accumulator unit.

13. The method according to claim 12, wherein processing at least one portion of a repetitive arithmetical/logical operation on the data comprises executing a visual processing primitive operation.

14. A computer program comprising computer program code to, when loaded into a computer and executed thereon, cause the computer to perform the steps of the method according to claim 12.
